(19) United States
(12) Patent Application Publication
(10) Pub. No.: US 2022/0191530 A1
(43) Pub. Date: Jun. 16, 2022

(54) INTRA PREDICTION METHOD AND DEVICE FOR PREDICTING AND DIVIDING PREDICTION UNIT INTO SUB-UNITS

(71) Applicants: Hyundai Motor Company, Seoul (KR); Kia Motors Corporation, Seoul (KR); Kwangwoon University Industry-Acadermic Collaboration Foundation, Seoul (KR)

(72) Inventors: Dong Gyu Sim, Seoul (KR); Jong Seok Lee, Seoul (KR); Sea Nae Park, Seoul (KR); Jun Taek Park, Seoul (KR); Seung Wook Park, Yongin, Gyeonggi-do (KR); Wha Pyeong Lim, Hwaseong, Gyeonggi-do (KR)

(21) Appl. No.: 17/438,263

(22) PCT Filed: Mar. 12, 2020
(86) PCT No.: PCT/KR2020/003445

§ 371 Date: Sep. 10, 2021

(30) Foreign Application Priority Data
Mar. 12, 2019 (KR) 10-2019-0028356

(51) Int. Cl. H04N 19/46; H04N 19/137; H04N 19/82; H04N 19/159; H04N 19/176

(52) U.S. Cl. CPC H04N 19/46; H04N 19/137; H04N 19/176; H04N 19/159; H04N 19/82

(57) ABSTRACT

A method and apparatus for intra prediction include a prediction unit that is divided into sub-units and predicted in the sub-units. A video decoding method includes: determining whether to split a current block into multiple subblocks; when the current block is split into the multiple subblocks, determining a split direction for the current block between a horizontal split direction and a vertical split direction and the number of the subblocks, based on split information decoded from a bitstream and a width and a height of the current block; reconstructing the current block by sequentially reconstructing the subblocks, that are specified according to the split direction and the number of the subblocks, using intra prediction; and setting a grid of N samples at regular intervals in horizontal and vertical directions and performing deblock-filtering on, among boundaries between the subblocks in the current block, boundaries that coincide with a boundary of the grid.

### CROSS-REFERENCE TO RELATED APPLICATION

This application is a National Phase filed under 35 USC 371 of PCT International Application No. PCT/KR2020/003445 filed on Mar. 12, 2020, which claims under 35 U.S.C. § 119(a) the benefit of Korean Patent Application No. 10-2019-0028356 filed on Mar. 12, 2019, the entire contents of which are incorporated by reference herein.

### BACKGROUND

### (a) Technical Field

The present disclosure relates to encoding and decoding of a video, more particularly, to a method and apparatus for intra prediction in which a prediction unit is divided into sub-units and predicted in the sub-units.

### (b) Description of the Related Art

Since video data has a large data volume compared to audio data or still image data, it requires a lot of hardware resources, including memory, to store or transmit the data in its raw form before undergoing a compression process.

Accordingly, storing or transmitting video data typically accompanies compression thereof by using an encoder before a decoder can receive, decompress, and reproduce the compressed video data. Existing video compression technologies include H.264/AVC and High Efficiency Video Coding (HEVC), which improves the encoding efficiency of H.264/AVC by about 40%.

However, the constant increase of video images in size, resolution, and frame rate and the resultant increase of data amount to be encoded require a new and superior compression technique with better encoding efficiency and higher image quality improvement over existing compression techniques.

Meanwhile, in intra prediction, prediction is performed with previously reconstructed samples located near the current block, where the neighboring sample used for intra prediction is referred to as a reference sample. Typically, intra prediction uses reference samples to predict all samples in the current block to the fullest. For example, with a 16×16 block, 256 sample values belonging to the 16×16 block are predicted by using their neighboring samples. Since a spatial correlation exists in the video, the closer a current block sample to the reference sample, the better the prediction results in general. Accordingly, current block samples adjacent to the reference samples may have accurate prediction values, yet those far from the reference samples may result in inaccurate prediction values.

The present disclosure generally seeks to provide an intra prediction technique for splitting a prediction unit into sub-units in a way to place reconstructed neighboring samples used for predicting the current sample to be closer to the current sample and predicting the sub-units of blocks by using a common intra-prediction mode.

### SUMMARY

At least one aspect of the present disclosure provides a video decoding method for reconstructing a current block using intra prediction, the method including a step of determining whether to split a current block into multiple subblocks, a step of determining, when the current block is split into multiple subblocks, a split direction for the current block between a horizontal split direction and a vertical split direction and the number of the subblocks based on split information decoded from a bitstream and a width and a height of the current block, a step of reconstructing the current block by sequentially reconstructing the subblocks, that are specified according to the split direction and the number of the subblocks, using intra prediction, and a step of setting a grid of N samples at regular intervals in horizontal and vertical directions and performing deblock-filtering on, among boundaries between the subblocks in the current block, boundaries that coincide with a boundary of the grid.

Another aspect of the present disclosure provides a video decoding apparatus for reconstructing a current block using intra prediction. The video decoding apparatus includes a means for determining whether to split a current block into multiple subblocks, a means for determining when the current block is split into multiple subblocks, a split direction for the current block between a horizontal split direction and a vertical split direction and the number of the subblocks based on split information decoded from a bitstream and a width and a height of the current block, a means for reconstructing the current block by sequentially reconstructing the subblocks, that are specified according to the split direction and the number of the subblocks, using intra prediction, and a means for setting a grid of N samples at regular intervals in horizontal and vertical directions and performing deblock-filtering on, among boundaries between the subblocks in the current block, boundaries that coincide with a boundary of the grid.

### BRIEF DESCRIPTION OF THE DRAWINGS

FIG. 1 is a block diagram illustrating a video encoding apparatus that can implement the techniques of the present disclosure.

FIG. 2 is a diagram for explaining a method of splitting a block by using a QTBTTT structure.

FIG. 3A is a diagram illustrating a plurality of intra-prediction modes.

FIG. 3B is a diagram illustrating a plurality of intra-prediction modes including wide-angle intra-prediction modes.

FIG. 4 is a block diagram illustrating a video decoding apparatus capable of implementing the techniques of the present disclosure.

FIGS. 5A to 5C are diagrams illustrating types in which a current block can be split into multiple subblocks when the current block is intra-prediction coded according to at least one embodiment of the present disclosure.

FIG. 6 is a functional block diagram illustrating an example configuration of an intra prediction unit in a video encoding apparatus according to at least one embodiment of the present disclosure.

FIG. 7 is a flowchart of a method performed by a video encoding apparatus for intra-prediction encoding a current block of a video, according to at least one embodiment of the present disclosure.

FIG. 8 is a functional block diagram illustrating an example configuration of an intra prediction unit in a video decoding apparatus, according to at least one embodiment of the present disclosure.

FIG. 9 is a flowchart of a method performed by a video decoding apparatus for decoding an intra-prediction encoded current block from a bitstream of an encoded video, according to at least one embodiment of the present disclosure.

FIGS. 10A and 10B are diagrams illustrating a coding block undergoing reconstruction sequentially in units of subblocks while generating a prediction subblock of a subblock.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

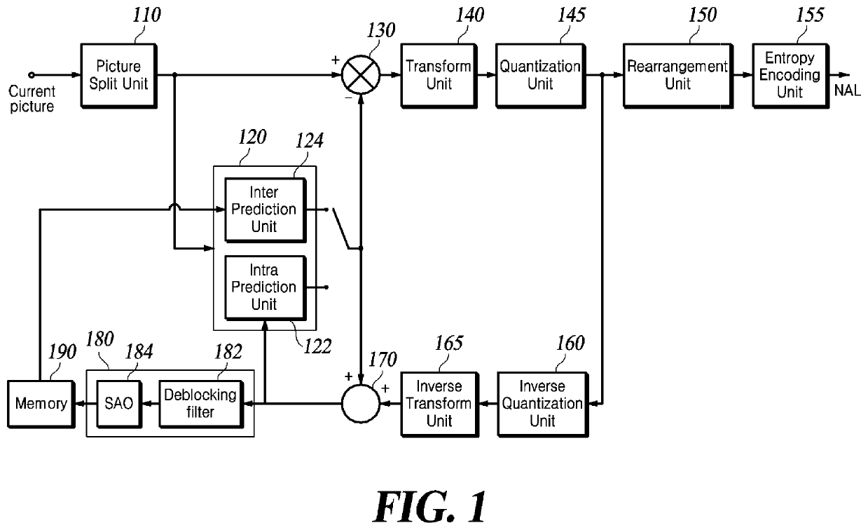

FIG. 1 is a block diagram illustrating a video encoding apparatus that can implement the techniques of the present disclosure. Hereinafter, a video encoding apparatus and sub-components of the apparatus will be described with reference to FIG. 1.

The video encoding apparatus may be configured including a picture split unit 110, a prediction unit 120, a subtractor 130, a transform unit 140, a quantization unit 145, a rearrangement unit 150, an entropy encoding unit 155, an inverse quantization unit 160, an inverse transform unit 165, an adder 170, a filter unit 180, and a memory 190.

The respective components of the video encoding apparatus may be implemented as hardware or software, or hardware and software combined. Additionally, the function of each component may be implemented by software and the function by software for each component may be implemented to be executed by a microprocessor.

A video is composed of a plurality of pictures. The pictures are each split into a plurality of regions, and encoding is performed for each region. For example, one picture is split into one or more tiles or/and slices. Here, one or more tiles may be defined as a tile group. Each tile or/and slice is split into one or more Coding Tree Units (CTUs). And each CTU is split into one or more Coding Units (CUs) by a tree structure. Information applied to the respective CUs are encoded as syntaxes of the CUs, and information commonly applied to CUs included in one CTU is encoded as a syntax of the CTU. Additionally, information commonly applied to all blocks in one slice is encoded as a syntax of a slice header, and information applied to all blocks constituting one picture is encoded in a Picture Parameter Set (PPS) or a picture header. Furthermore, information commonly referenced by a plurality of pictures is encoded in a Sequence Parameter Set (SPS). Additionally, information commonly referenced by one or more SPSs is encoded in a Video Parameter Set (VPS). In the same manner, information commonly applied to one tile or tile group may be encoded as a syntax of a tile header or tile group header.

The picture split unit 110 determines the size of a coding tree unit (CTU). Information on the size of the CTU (CTU size) is encoded as a syntax of the SPS or PPS and transmitted to a video decoding apparatus.

The picture split unit 110 splits each picture constituting the video into a plurality of coding tree units (CTUs) having a predetermined size and then uses a tree structure to split the CTUs recursively. A leaf node in the tree structure becomes a coding unit (CU), which is a basic unit of encoding.

The tree structure may be a QuadTree (QT) in which an upper node (or parent node) is split into four equally sized lower nodes (or child nodes), a BinaryTree (BT) in which an upper node is split into two lower nodes, a TernaryTree (TT) in which an upper node is split into three lower nodes in a size ratio of 1:2:1, or a combination of two or more of the QT structure, BT structure, and TT structure. For example, a QuadTree plus BinaryTree (QTBT) structure may be used, or a QuadTree plus BinaryTree TernaryTree (QTBTTT) structure may be used. Here, BTTT may be collectively referred to as a Multiple-Type Tree (MTT).

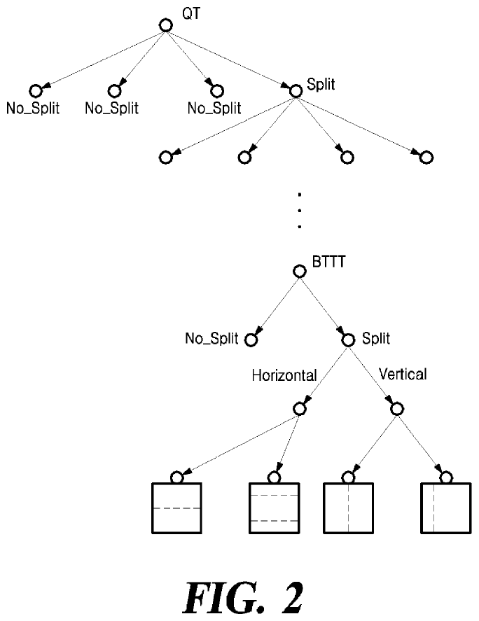

FIG. 2 shows a QTBTTT split tree structure. As shown in FIG. 2, the CTU may be first split into a QT structure. The quadtree splitting may be repeated until the size of a splitting block reaches the minimum block size (MinQTSize) of a leaf node allowed in QT. A first flag (QT_split_flag) indicating whether each node of the QT structure is split into four nodes of a lower layer is encoded by the entropy encoding unit 155 and signaled to the video decoding apparatus. When the leaf node of the QT is not larger than the maximum block size (MaxBTSize) of the root node allowed in the BT, it may be further split into any one or more of the BT structure or the TT structure. In the BT structure and/or the TT structure, there may be a plurality of split directions. For example, there may be two directions in which the block of the relevant node is split horizontally and vertically. As shown in FIG. 2, when MTT splitting starts, a second flag (mtt_split_flag) indicating whether the nodes are split, and if yes, a further flag indicating split directions (vertical or horizontal) and/or a flag indicating partition or split type (binary or ternary) is encoded by the entropy encoding unit 155 and signaled to the video decoding apparatus.

Alternatively, before encoding the first flag (QT_split_flag) indicating whether each node is split into four nodes of a lower layer, a CU split flag (split_cu_flag) may be encoded indicating whether the node is split or not. When the CU split flag (split_cu_flag) value indicates that splitting is not performed, the block of the corresponding node becomes a leaf node in the split tree structure and serves a coding unit (CU), which is a basic unit of coding. When the CU split flag (split_cu_flag) value indicates that the node was split, the video encoding apparatus starts encoding from the first flag in an above-described manner.

As another example of the tree structure, when QTBT is used, there may be two types of partition including a type that horizontally splits the block of the relevant node into two equally sized blocks (i.e., symmetric horizontal partition) and a type that splits the same vertically (i.e., symmetric vertical partition). Encoded by the entropy encoding unit 155 and transmitted to the video decoding apparatus are a split flag (split_flag) indicating whether each node of the BT structure is split into blocks of a lower layer and partition type information indicating its partition type. Meanwhile, there may be a further type in which the block of the relevant node is split into two asymmetrically formed blocks. The asymmetric form may include a form of the block of the relevant node being split into two rectangular blocks having a size ratio of 1:3 or a form of the block of the relevant node being split in a diagonal direction.

A CU may have various sizes depending on the QTBT or QTBTTT split of the CTU. Hereinafter, a block corresponding to a CU to be encoded or decoded (i.e., a leaf node of QTBTTT) is referred to as a ‘current block’. With QTBTTT splitting employed, the shape of the current block may be not only a square but also a rectangle.

The prediction unit 120 predicts the current block to generate a prediction block. The prediction unit 120 includes an intra prediction unit 122 and an inter prediction unit 124.

In general, the current blocks in a picture may each be predictively coded. Prediction of the current block may be generally performed using an intra prediction technique or inter prediction technique, wherein the intra prediction technique uses data from a picture containing the current block and the inter prediction technique uses data from a picture which has been coded before the picture containing the current block. Inter prediction includes both unidirectional prediction and bidirectional prediction.

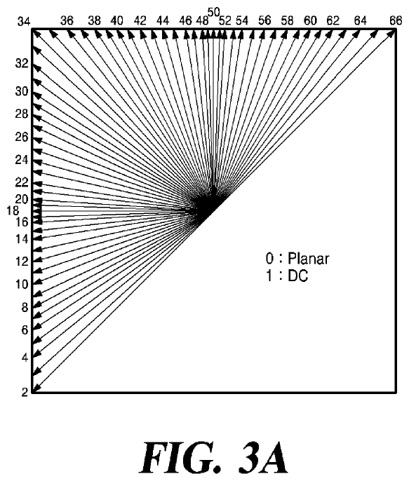

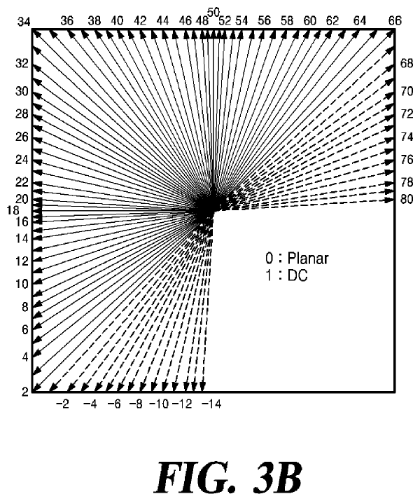

The intra prediction unit 122 predicts pixels in the current block by using the neighboring pixels (reference pixels) located around the current block in the current picture. There is a plurality of intra-prediction modes according to the prediction directions. For example, as shown in FIG. 3A, the multiple intra-prediction modes may include 2 non-directional modes including a planar mode, a DC mode, and 65 directional modes. The respective prediction modes provide different corresponding definitions of the neighboring pixels and the calculation formula to be used.

For efficient directional prediction of a rectangular-shaped current block, additional directional modes may be used as illustrated in FIG. 3B by dotted arrows of intra-prediction modes at Nos. 67 to 80 and No. −1 to No. −14. These may be referred to as “wide-angle intra-prediction modes”. Arrows in FIG. 3B indicate corresponding reference samples to be used for prediction, not prediction directions. The prediction direction is opposite to the direction indicated by the arrow. A wide-angle intra prediction mode is a mode in which prediction is performed in a direction opposite to a specific directional mode without additional bit transmission, when the current block has a rectangular shape. In this case, among the wide-angle intra-prediction modes, some wide-angle intra-prediction modes available for use in the current block may be determined by the ratio of the width to the height of the rectangular current block. For example, the wide-angle intra-prediction modes that have an angle smaller than 45 degrees (intra-prediction modes at Nos. 67 to 80) may be used when the current block has a rectangular shape with the height less than the width. The wide-angle intra-prediction modes having an angle of −135 degrees or greater (intra-prediction modes at Nos. −1 to −14) may be used when the current block has a rectangular shape with the height greater than the width.

The intra prediction unit 122 may determine an intra-prediction mode to be used for encoding the current block. In some examples, the intra prediction unit 122 may encode the current block by using several intra-prediction modes and select an appropriate intra-prediction mode to use from tested modes. For example, the intra prediction unit 122 may calculate rate-distortion values through rate-distortion analysis of several tested intra-prediction modes and select an intra-prediction mode that has the best rate-distortion characteristics among the tested modes.

The intra prediction unit 122 selects one intra-prediction mode from among a plurality of intra-prediction modes and predicts the current block by using at least one neighboring pixel (reference pixel) determined according to the selected intra-prediction mode and calculation formula. Information on the selected intra-prediction mode is encoded by the entropy encoding unit 155 and transmitted to the video decoding apparatus.

The inter prediction unit 124 generates a prediction block for the current block through a motion compensation process. The inter prediction unit 124 searches for a block most similar to the current block in a reference picture which has been encoded and decoded earlier than the current picture, and generates a prediction block of the current block by using the searched block. Then, the inter prediction unit 124 generates a motion vector corresponding to the displacement between the current block in the current picture and the prediction block in a reference picture. In general, motion estimation is performed on a luma component, and a motion vector calculated based on the luma component is used for both the luma component and the chroma component. Motion information including information on the reference picture and information on the motion vector used to predict the current block is encoded by the entropy encoding unit 155 and transmitted to the video decoding apparatus.

The subtractor 130 generates a residual block by subtracting, from the current block, the prediction block generated by the intra prediction unit 122 or the inter prediction unit 124.

The transform unit 140 transforms the residual signal in the residual block having pixel values in the spatial domain into transform coefficients in the frequency domain. The transform unit 140 may transform the residual signals in the residual block by using the full size of the residual block as a transform unit, or separate the residual block into two subblocks that are a transform region and a non-transform region and transform the residual signals by using the transform-region subblock alone as a transform unit. Here, the transform-region subblock may be one of two rectangular blocks having a size ratio of 1:1 in the horizontal axis (or vertical axis). In this case, the flag (cu_sbt_flag) indicating that only a single subblock is transformed, directional (vertical/horizontal) information (cu_sbt_horizontal_flag), and/or position information (cu_sbt_pos_flag) are encoded by the entropy encoding unit 155 and signaled to the video decoding apparatus. Additionally, the size of the transform-region subblock may have a size ratio of 1:3 in the horizontal axis (or vertical axis). In this case, a flag (cu_sbt_quad_flag) distinguishing the corresponding splitting is additionally encoded by the entropy encoder 155 and signaled to the video decoding apparatus.

Meanwhile, a maximum and/or minimum transform size may be defined for a transform. A transform is disallowed from using a transform unit with a size smaller than the minimum transform size. Additionally, when the residual block of the current block is larger than the maximum transform size, the transform unit 140 splits the residual block into subblocks having a size equal to or less than the maximum transform size and performs the transform by using the subblocks as transform units. Here, the maximum and/or minimum transform size may be defined as a fixed size arranged between the video encoding apparatus and the video decoding apparatus. Alternatively, information on the maximum and/or minimum transform size may be included in the SPS or the PPS and signaled from the video encoding apparatus to the video decoding apparatus.

The quantization unit 145 quantizes the transform coefficients outputted from the transform unit 140 and outputs the quantized transform coefficients to the entropy encoding unit 155.

The rearrangement unit 150 may perform rearrangement of the coefficient values with the quantized transform coefficients. The rearrangement unit 150 may use coefficient scanning for changing the two-dimensional coefficient array into a one-dimensional coefficient sequence. For example, the rearrangement unit 150 may scan coefficients from a DC coefficient toward coefficients in a high-frequency region through a zig-zag scan or a diagonal scan to output a one-dimensional coefficient sequence. Depending on the size of the transform unit and the intra-prediction mode, the zig-zag scan used may be replaced by a vertical scan for scanning the two-dimensional coefficient array in a column direction and a horizontal scan for scanning the two-dimensional block shape coefficients in a row direction. In other words, a scanning method to be used may be determined among a zig-zag scan, a diagonal scan, a vertical scan, and a horizontal scan according to the size of the transform unit and the intra-prediction mode.

The entropy encoding unit 155 encodes a sequence of the one-dimensional quantized transform coefficients outputted from the rearrangement unit 150 by using various encoding methods such as Context-based Adaptive Binary Arithmetic Code (CABAC), Exponential Golomb, and the like, encoding to generate a bitstream.

Additionally, the entropy encoding unit 155 encodes information on block partition, such as CTU size, CU split flag, QT split flag, MTT split type, and MTT split direction for allowing the video decoding apparatus to split the block in the same way as the video encoding apparatus. Additionally, the entropy encoding unit 155 encodes information on a prediction type indicating whether the current block is encoded by intra prediction or inter prediction and further encodes, depending on the prediction type, intra prediction information (i.e., information on intra-prediction mode) or inter prediction information (i.e., information on reference pictures and motion vectors).

The inverse quantization unit 160 inversely quantizes the quantized transform coefficients outputted from the quantization unit 145 to generate transform coefficients. The inverse transform unit 165 transforms the transform coefficients outputted from the inverse quantization unit 160 from the frequency domain to the spatial domain to reconstruct the residual block.

The adder 170 adds up the reconstructed residual block and the prediction block generated by the prediction unit 120 to reconstruct the current block. Pixels in the reconstructed current block are used as reference pixels when intra-predicting a next block.

The filter unit 180 performs filtering on the reconstructed pixels to reduce blocking artifacts, ringing artifacts, blurring artifacts, etc. generated due to block-based prediction and transform/quantization. The filter unit 180 may include a deblocking filter 182 and a sample adaptive offset (SAO) filter 184.

The deblocking filter 180 filters the boundary between the reconstructed blocks to remove a blocking artifact caused by block-by-block encoding/decoding, and the SAO filter 184 performs additional filtering on the deblock-filtered image. The SAO filter 184 is a filter used to compensate for a difference between a reconstructed pixel and an original pixel caused by lossy coding.

The reconstructed block is filtered through the deblocking filter 182 and the SAO filter 184 and stored in the memory 190. When all blocks in one picture are reconstructed, the reconstructed picture may be used as a reference picture for inter-prediction of blocks in a coming picture to be encoded.

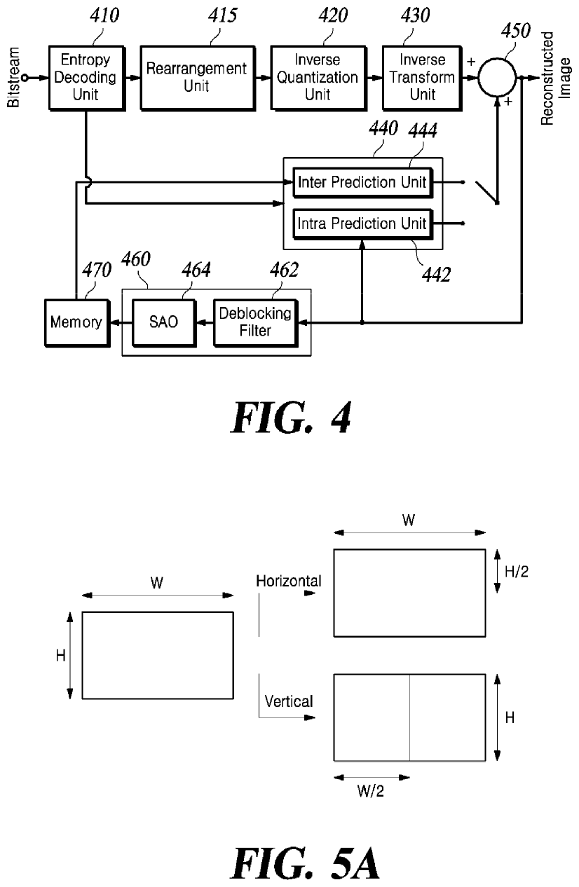

FIG. 4 is a functional block diagram illustrating a video decoding apparatus capable of implementing the techniques of the present disclosure. Hereinafter, the video decoding apparatus and sub-components of the apparatus will be described referring to FIG. 4.

The video decoding apparatus may be configured including an entropy decoding unit 410, a rearrangement unit 415, an inverse quantization unit 420, an inverse transform unit 430, a prediction unit 440, an adder 450, a filter unit 460, and a memory 470.

As with the video encoding apparatus of FIG. 1, the respective components of the video decoding apparatus may be implemented as hardware or software, or hardware and software combined. Additionally, the function of each component may be implemented by software and the function by software for each component may be implemented to be executed by a microprocessor.

The entropy decoding unit 410 decodes the bitstream generated by the video encoding apparatus and extracts information on block partition to determine the current block to be decoded, and extracts prediction information and information on residual signal, and the like required to reconstruct the current block.

The entropy decoding unit 410 extracts information on the CTU size from a sequence parameter set (SPS) or a picture parameter set (PPS), determines the size of the CTU, and splits the picture into CTUs of the determined size. Then, the entropy decoding unit 410 determines the CTU as the highest layer, i.e., the root node of the tree structure, and extracts the split information on the CTU, and thereby splits the CTU by using the tree structure.

For example, when splitting the CTU by using the QTBTTT structure, a first flag (QT_split_flag) related to QT splitting is first extracted and each node is split into four nodes of a lower layer. For the node corresponding to the leaf node of QT, the entropy decoding unit 410 extracts the second flag (MTT_split_flag) related to the partition of MTT and information of the split direction (vertical/horizontal) and/or split type (binary/ternary) so as to split the corresponding leaf node by an MTT structure. This allows the respective nodes below the leaf node of QT to be recursively split into a BT or TT structure.

As another example, when splitting the CTU by using the QTBTTT structure, the entropy decoding unit 410 may first extract a CU split flag (split_cu_flag) indicating whether a CU is split. When the relevant block is split, it may extract a first flag (QT_split_flag). In the splitting process, each node may have zero or more recursive QT splits followed by zero or more recursive MTT splits. For example, the CTU may immediately enter MTT split, or conversely, have multiple QT splits alone.

As yet another example, when splitting the CTU by using the QTBT structure, the entropy decoding unit 410 extracts a first flag (QT_split_flag) related to QT splitting to split each node into four nodes of a lower layer. And, for a node corresponding to a leaf node of QT, the entropy decoding unit 410 extracts a split flag (split_flag) indicating whether that node is or is not further split into BT and split direction information.

Meanwhile, when the entropy decoding unit 410 determines the current block to be decoded through the tree-structure splitting, it extracts information on a prediction type indicating whether the current block was intra-predicted or inter-predicted. When the prediction type information indicates intra prediction, the entropy decoding unit 410 extracts a syntax element for intra prediction information (intra-prediction mode) of the current block. When the prediction type information indicates inter-prediction, the entropy decoding unit 410 extracts a syntax element for the inter-prediction information, that is, information indicating a motion vector and a reference picture referenced by the motion vector.

Meanwhile, the entropy decoding unit 410 extracts information on the quantized transform coefficients of the current block as information on the residual signal.

The rearrangement unit 415 changes, in a reverse order of the coefficient scanning performed by the video encoding apparatus, the sequence of the one-dimensional quantized transform coefficients entropy-decoded by the entropy decoding unit 410 into a two-dimensional coefficient array (i.e. block).

The inverse quantization unit 420 inversely quantizes the quantized transform coefficients. The inverse transform unit 430 inversely transforms the inverse quantized transform coefficients from the frequency domain to the spatial domain to reconstruct the residual signals, and thereby generate a residual block of the current block.

Additionally, when the inverse transform unit 430 inversely transforms only a partial region (subblock) of the transform block, it extracts a flag (cu_sbt_flag) indicating that only the subblock of the transform block has been transformed, the subblock's directionality (vertical/horizontal) information (cu_sbt_horizontal_flag), and/or subblock's position information (cu_sbt_pos_flag), and inversely transforms the transform coefficients of the subblock from the frequency domain to the spatial domain to reconstruct the residual signals. At the same time, the inverse transform unit 430 fills the remaining region which is not inversely transformed with the “0” value as the residual signals, and thereby generates the final residual block for the current block. Meanwhile, no transform is allowed when using a transform unit with a size smaller than the minimum transform size. Additionally, when the residual block of the current block is larger than the maximum transform size, the inverse transform unit 430 splits the residual block into subblocks having a size equal to or less than the maximum transform size and performs the inverse transform by using the subblocks as transform units.

The prediction unit 440 may include an intra prediction unit 442 and an inter-prediction unit 444. The intra prediction unit 442 is activated when the prediction type of the current block is intra prediction, and the inter prediction unit 444 is activated when the prediction type of the current block is inter prediction.

The intra prediction unit 442 determines, among a plurality of intra-prediction modes, the intra-prediction mode of the current block from the syntax element for the intra-prediction mode extracted by the entropy decoding unit 410, and according to the determined intra-prediction mode, it predicts the current block by using neighboring reference pixels of the current block. The intra-prediction mode determined by the syntax element for the intra-prediction mode may be a value indicating one of all intra-prediction modes (e.g., a total of 67 modes) as described above. In a case where the current block is rectangular, some directional modes among the total of 67 modes may be replaced with one of the wide-angle intra-prediction modes based on the ratio of the width to the height of the current block.

The inter prediction unit 444 utilizes the syntax element for the intra-prediction mode extracted by the entropy decoding unit 410 to determine a motion vector of the current block and a reference picture referenced by the motion vector, and it utilizes the motion vector and the reference picture to predict the current block.

The adder 450 adds up the residual block outputted from the inverse transform unit and the prediction block outputted from the inter prediction unit or the intra prediction unit to reconstruct the current block. Pixels in the reconstructed current block are used as reference pixels when intra-predicting coming blocks to be decoded.

The filter unit 460 may include a deblocking filter 462 and an SAO filter 464. The deblocking filter 462 performs deblock-filtering on the boundary between reconstructed blocks to remove a blocking artifact caused by block-by-block decoding. The SAO filter 464 performs additional filtering on the reconstructed block after the deblock-filtering to compensate for the difference between the reconstructed pixel and the original pixel caused by lossy coding. The reconstructed block is filtered through the deblocking filter 462 and the SAO filter 464 and stored in the memory 470. When all blocks in one picture are reconstructed, the reconstructed picture is used as a reference picture for inter-prediction of coming blocks to be coded within a picture.

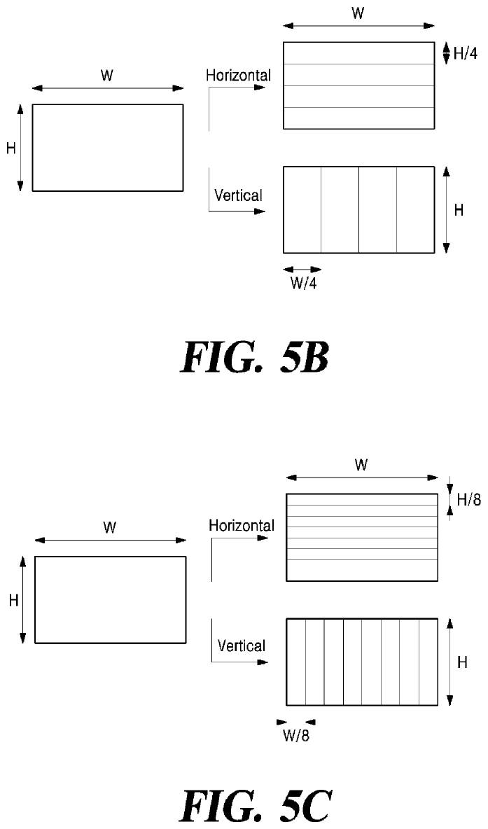

The techniques of the embodiments illustrated here generally relate to intra-prediction coding, i.e., encoding and decoding, of a current block. Accordingly, certain techniques of the present disclosure may be performed by the intra prediction unit 122 or the intra prediction unit 442. In some embodiments, the intra prediction unit 122 or the intra prediction unit 442 performs the techniques of the present disclosure described with reference to FIGS. 5 to 9 to follow. In other embodiments, one or more other units of the video encoding apparatus or the video decoding apparatus may be further involved in performing the techniques of the present disclosure. The following description mainly focuses on the decoding technology, in particular, the operation of the video decoding apparatus, and it will keep the encoding technology concise because the latter is the reverse of the comprehensively described decoding technology.

In intra prediction, prediction is performed with previously reconstructed samples that neighbor the current block, where the neighboring sample used for intra prediction is referred to as a reference sample. Typically, in intra prediction, all samples in the current block are predicted as a whole using the reference samples. For example, with a 16×16 block, 256 sample values belonging to the 16×16 block are predicted by using their neighboring samples. Since a spatial correlation exists in the video, the closer a current block sample to the reference sample, the better the prediction results in general. Accordingly, in a vertical prediction mode (mode 50 in FIG. 3B) or a horizontal prediction mode (mode 18 in FIG. 3B), current block samples adjacent to the reference samples may have accurate prediction values, yet those far from the reference samples may result in inaccurate prediction values.

An intra coding tool described below is related to splitting a CU depending on its size into a plurality of subblocks of equal size in a vertical or horizontal direction and performing prediction for each subblock in the same intra-prediction mode. The reconstructed sample values (or predicted sample values) of each subblock are available for the prediction of the next subblock, which is iteratively applied for the respective subblocks. For example, when the current block (CU) is divided into four parallel subblocks, the first subblock may be predicted from neighboring samples of the current block (CU), the second subblock may be predicted from its neighboring pixels including samples of the first subblock, a third subblock may be predicted from its neighboring samples including samples of the second subblock, and a fourth subblock may be predicted from neighboring samples including samples of the third subblock. In this way, instead of predicting all pixels of the current block (CU) from samples of previously encoded or decoded blocks adjacent to the current block (CU), samples in the current block (CU) may be used to predict other samples in the same current block (CU).

One advantage of the intra coding tool provided by this disclosure is that reconstructed neighboring samples tend to be much closer to the predicted sample than in an ordinary scenario of intra prediction. Located closer to the current sample as a basis for predicting the current sample, the reconstructed neighboring samples can improve the accuracy of the prediction of the current sample.

1. Subblock Partitioning and Signaling

FIGS. 5A to 5C are diagrams illustrating types in which a current block can be split into multiple subblocks when the current block is intra-prediction coded according to at least one embodiment of the present disclosure. The minimum block size applicable to the intra coding tool of the present disclosure may be 4×8 or 8×4. Additionally, a constraint may be added that all subblocks have a minimum of 16 samples. As shown in FIGS. 5A to 5C, the block when sized 4×8 or 8×4 is divided into two, and the block larger than this may be divided into 4 or 8 blocks. A CU size for which the intra coding tool may be used may be limited to a maximum of 64×64 due to a virtual pipeline data unit (VPDU), which is a processing unit of VVC.

The video encoding apparatus may signal a split flag indicating that the current block was split into multiple subblocks and intra-predicted by each subblock. Accordingly, the video decoding apparatus may decode the split flag from the bitstream of the video data and determine whether to split the current block based on the split flag. A split flag of a first value (e.g., “0”) indicates that the current block was not split into multiple subblocks, and a split flag of a second value (e.g., “1”) indicates that the current block has been split into multiple subblocks and intra-predicted by each subblock.

The split flag may be inferred by the video decoding apparatus with no explicit signaling, i.e., with no decoding from the bitstream, but instead depending on the width and height of the current block, the area of the current block, the minimum transform size and/or the maximum transform size allowed for transforming transform coefficients.

In at least one embodiment, when the width and height of the current block are smaller than the minimum transform size, the split flag may need no decoding from the bitstream, but instead, be set to a first value indicating that the current block is not split. In another embodiment, when the area of the current block (i.e., the number of pixels included in the current block) is smaller than the area of the transform unit (i.e., the number of pixels included in the transform unit) defined by the minimum transform size, the split flag may need no decoding from the bitstream, but instead, be set to a first value indicating that the current block is not split. In yet another embodiment, when the width and height of the current block are greater than the maximum transform size, the split flag may not be decoded from the bitstream. In this case, it can be inferred that the split flag has a second value, i.e., that the current block has been split into multiple subblocks and intra-predicted by each subblock. Alternatively, it may be inferred that the split flag has the first value. In other words, when the width and height of the current block are greater than the maximum transform size, when the coding tool of the present disclosure, which split the current block into multiple subblocks and performs intra prediction for each subblock, may not be applied to the current block. In yet another embodiment, when the current block is located at the boundary of a picture (or tile), the intra coding tool of the present disclosure is not used for the current block, and the split flag is inferred to have the first value. Alternatively, the current block when located at the boundary of the picture (or tile) may accompany the usage of the intra coding tool of the present disclosure, and thus the split flag is inferred to have the second value, thereby obviating the need for additional block partitioning of the CTU at the picture boundary.

Additionally, when the intra coding tool of the present disclosure is applied to the current block, information on the direction and number of subblock partitions may be provided in various ways. For example, the direction and number of subblock partitions may be determined based on syntax elements (e.g., flags) extracted from the bitstream, the size of the current block, the position of the current block, the length (i.e., width or height) of one side of the current block, the number of pixels included in the current block, the intra-prediction mode of the current block, the size of the minimum or maximum transform block, and the like.

In some embodiments, when the current block is split into multiple subblocks, the video decoding apparatus may determine the partition direction and the number of subblocks based on split information decoded from the bitstream and the width and height of the current block.

In particular, the number of subblocks may be determined by the width and height of the current block. For example, as shown in Table 1, when the width and height of the current block are 4×8 or 8×4, the number of subblocks is determined to be 2, and when the width and height of the current block are greater than 4×4 and not equal to 4×8 and 8×4, the number of subblocks may be determined to be 4. As another example, as shown in Table 2, when the width and height of the current block are 4×8 or 8×4, the number of subblocks is determined to be 2, and when the width and height of the current block are 8×N to 32×N or N×8 to N×32 (here, N>4), the number of subblocks may be determined to be 4. Further, the number of subblocks may be determined to be 8 for current blocks larger than 32×N and N×32.

TABLE 1

| Current Block Size | No. of Subblocks |
|---|---|
| 4 × 4 | Not Divided |
| 4 × 8 and 8 × 4 | 2 |
| Others | 4 |

TABLE 2

| Current Block Size | No. of Subblocks |
|---|---|
| 4 × 4 | Not Divided |
| 4 × 8 and 8 × 4 | 2 |
| 4 × 8 and | 4 |
| 8 × 4~32 × N | |
| and N × 32 | |
| Others | 8 |

Whether the split direction is horizontal or vertical may be determined by the split information. Alternatively or supplementally, the split direction may be determined (or inferred) based on the ratio of the width to height of the current block. For example, the split direction may be determined to be horizontal when the width of the current block is greater than its height and may be determined to be vertical when the width of the current block is smaller than its height.

Alternatively or supplementally, when the current block exists at the boundary of a picture (or a tile, a group of tiles, etc.), the split shape and the number of subblocks may be inferred according to the position of the current block.

Additionally, whether the split direction is horizontal or vertical may be determined based on the directionality of prediction modes included in intra-prediction mode candidates (i.e., MPM list) determined for the current block. As an example, when relatively horizontal intra-prediction modes, e.g., modes 3 to 33 shown in FIG. 3B (hereinafter “horizontal-oriented modes”) exist or dominate in the MPM list, the split direction may be determined to be vertical. And when relatively vertical intra-prediction modes, e.g., modes 35 to 65 shown in FIG. 3B (hereinafter “vertical-oriented modes”) exist or dominate in the MPM list, the split direction may be determined to be horizontal.

2. Determination of Intra-Prediction Mode

When the intra coding tool of the present disclosure is applied to a current block, the intra-prediction mode determined for the current block may be commonly applied to intra prediction of subblocks of the current block.

A wide-angle intra-prediction mode may still be used for the current block to which the intra coding tool of the present disclosure is applied. In this case, the wide-angle intra-prediction mode may be determined by the ratio between the width and the height of the current block, not the ratio between the width and the height of the subblock divided from the current block.

The video decoding apparatus may determine the intra-prediction mode of the current block by decoding, from the bitstream, intra-prediction mode information of the current block. For example, the video decoding apparatus selects a predetermined number of intra-prediction mode candidates from among a plurality of intra-prediction modes and uses intra-prediction mode information of the current block for determining, from among intra-prediction mode candidates (i.e., MPM list), the intra-prediction mode of the current block.

Intra-prediction mode candidates may be selected in different ways depending on whether the split direction is horizontal or vertical. For example, when the split direction is horizontal, vertical-oriented modes among a plurality of intra-prediction modes may be selected as the intra-prediction mode candidates in preference to horizontal-oriented modes. Additionally, when the split direction is vertical, horizontal-oriented modes among a plurality of intra-prediction modes may be selected as the intra-prediction mode candidates in preference to the vertical-oriented modes. As another example, when the split direction is horizontal, horizontal modes (e.g., mode 18 of FIG. 3B) or horizontal-oriented modes may be excluded from the selection of intra-prediction mode candidates, and when the split direction is vertical, vertical modes (e.g., 50 of FIG. 3B) or vertical-oriented modes may be excluded from selection of intra-prediction mode candidates.

3. Generation of Intra Prediction Block in Units of Subblocks

The video decoding apparatus reconstructs the current block by sequentially reconstructing multiple subblocks using the intra-prediction mode determined for the current block. For example, the video decoding apparatus may generate an intra-predicted subblock by predicting, from reconstructed pixels around the subblock, a target subblock to be currently reconstructed from among the multiple subblocks. The video decoding apparatus may reconstruct transform coefficients by decoding, from a bitstream, transform coefficient information corresponding to the target subblock, and may inverse quantize and inverse transform the transform coefficients by using the same transform size as that of the target subblock, thereby generating the residual subblock having residual signals. The video decoding apparatus may reconstruct the target subblock by using the intra-predicted subblock and the residual subblock. In particular, pixels in the reconstructed subblock may be used to intra-predict the next subblock in the current block. By this process, the subblocks of the current block are processed beginning at the subblock including the top-left sample of the current block to subblocks in the downward direction sequentially when the split direction is horizontal, and to subblocks in the right direction sequentially when the split direction is vertical.

In some cases, to keep the width of the minimum prediction unit for the subblocks to be 4 samples, the dependence of the prediction of the 1×N/2×N sub-block on the reconstructed values of the previously decoded 1×N/2×N sub-block of the current block may not be allowed. In other words, when the intra coding tool of the present disclosure is applied to the current block, transform in 1×N and 2×N units is allowed, but prediction in 1×N and 2×N units may not be allowed. For example, an 8×N (N>4) current block partitioned in the vertical direction may be split into four 2×N subblocks. Accordingly, the residual signals of the current block are generated by being reconstructed and inversely transformed in units of 2×N subblocks. However, since no prediction is allowed in units of 2×N subblocks, the current block is predicted in units of 4×N subblocks having a width of 4 samples. In other words, an 8×N (N>4) current block partitioned in the vertical direction may be split into two 4×N prediction regions and four 2×N transform regions. Additionally, a 4×N current block divided in the vertical direction may be predicted as a 4×N prediction region and split into four 1×N transform regions. This is a constraint due to the typical hardware design feature storing the results of intra-predicted blocks as separated in multiple clocks in row units, which requires the number of clocks used for processing 1×N or 2×N blocks to keep from exceeding the clock count for 4×N blocks.

4. In-loop Filtering

The video decoding apparatus may perform in-loop filtering including deblock-filtering on the reconstructed current block, and may store the filtered current block in a buffer (e.g., memory 470 of FIG. 4) for use as a reference picture to inter-predict blocks to be coded in the outstanding picture.

In an illustrative embodiment, the video decoding apparatus sets a grid of M samples at regular intervals on a CTU or picture containing the current block in the horizontal and vertical directions and performs deblock-filtering on boundaries that coincide with the boundaries of the grid, among the boundaries between the multiple subblocks in the current block to which the intra coding tool of the present disclosure is applied. Accordingly, deblock-filtering may not be performed on boundaries between the multiple subblocks that do not coincide with the grid boundary. For example, when performing the deblock-filtering in 8×8 units, the deblock-filtering may be performed only on the boundary between subblocks matching the boundary of the 8×8 unit grid among the boundaries between subblocks of 2×N (or N×2) or 4×N (or N×4) size. Although a grid of 8×8 units is given as an example, the grid size is not necessarily limited to 8×8. For example, the number M of the samples may be expressed in the form of 2ⁿ (n is a natural number), and may have any one value of 4, 8, 16, and the like.

In some cases, in-loop filtering may be performed only on a part of the boundary between subblocks according to the subblock split direction and the number of partitions. For example, with the current block split in the horizontal direction, only vertical deblock-filtering may be performed and horizontal deblock-filtering may be omitted. Similarly, with the current block split in the vertical direction, only the deblock-filtering in the horizontal direction may be performed and the deblock-filtering in the vertical direction may be omitted.

In some embodiments, when the intra coding tool of the present disclosure is applied to the current block, it may be determined whether in-loop filtering is performed in units of each subblock. Accordingly, the video decoding apparatus may check whether in-loop filtering is performed in units of each subblock or may check the same through high-level syntax.

When performing in-loop filtering on the current block, the method of performing the in-loop filtering process or the method of calculating parameters of the in-loop filtering may differ according to criteria calculated based on at least one of the information items of the subblock size, location, depth, QP, and the like.

For example, when the intra coding tool of the present disclosure is applied to the current block, the subblock of the current block may be smaller than the unit in which calculation is performed on the in-loop filtering parameters, e.g., parameters for determining the intensity of the filter and the clipping value for the change of the pixel. In this case, instead of calculating the filtering parameters in units of subblocks, filtering parameters may be calculated with respect to the current block, and in-loop filtering may be performed in units of each subblock. Alternatively, common filtering parameters may be calculated with respect to every two or more subblocks combined, and those subblocks may share the common filtering parameters.

As another example, when the unit for calculating the ALF parameters spans the boundary of the subblock, the ALF parameters may be obtained in units of, e.g., {N×1, 1×N, N×2, 2×N} to perform the ALF. In another example, the present disclosure can avoid calculating parameters for determining whether to perform deblock-filtering (or filter coefficients) by configuring deblock-filtering to be ever performed or never performed on the current block. As another example, the present disclosure is responsive to whether the boundary of the current subblock overlaps the boundary of a CU (or CTU or VPDU) for adaptively changing the method of performing the in-loop filtering or the method of calculating the parameters.

5. Signaling Coded Block Flag

When the intra coding tool of the present disclosure is applied to the current block, a syntax element (e.g., coded block flag; CBF) may be signaled for each subblock, indicating whether at least one non-zero coefficient exists in that subblock. For example, a CBF of “0” may indicate that all coefficients in the relevant subblock are zero coefficients, and a CBF of “1” may indicate that at least one non-zero coefficient exists in the relevant subblock.

The CBF may be inferred based on the number of subblocks divided, the size (width or height) of the subblocks, the intra-prediction mode, the position of the block, the QP, the number of pixels included in the subblock, and the like. For example, it is considered that at least one CBF for subblocks of the current block is not “0.” Accordingly, when the current block has n subblocks and the CBFs of the previous n−1 subblocks are all “0,” the CBF of the n-th subblock is inferred to be “1” and thus CBFs are not explicitly signaled.

As another example, when the width or height of subblocks of a given current block is not greater than 2, the intra coding tool of the present disclosure may be applied only when the CBF of each subblock is not 0. In this case, for example, when the intra coding tool of the present disclosure is applied to the 8×16 current block and is divided into 4 2×16 subblocks, the CBF of each subblock is inferred to be “1” and thus is not explicitly signaled. On the other hand, if the 8×16 current block is divided into two 4×16 subblocks, the CBF of each subblock must be explicitly signaled.

6. Signaling Quantization Parameter

The video encoding apparatus determines a quantization parameter (QP) value for the current block (CU) and determines a delta quantization parameter (DQP) value for the current block based on the QP value and the QP prediction value. The video encoding apparatus may be configured to signal a DQP value and quantize the current block by using the determined QP value. The video encoding apparatus may adjust the QP value for the current block and thereby adjust the degree of quantization applied to coefficient blocks related to the current block.

DQP is defined as the difference between the current QP (i.e., the actual QP used in the current block) and the current QP's prediction value (i.e., the QP prediction value). Based on the signaled DQP, the corresponding current QP value may be reconstructed by summing the DQP to the QP prediction value. In other words, in the video encoding apparatus, the DQP is calculated by subtracting the QP prediction value from the actual QP of the current block, and in the video decoding apparatus, the actual QP of the current block is reconstructed by adding the received DQP to the QP prediction value. In some examples, the QP prediction value is defined for the current block as the average of the actual QP values for the upper block and the left block.

The video decoding apparatus may be configured to receive the DQP value for the current quantization block, determine the QP value for the current quantization block based on the received DQP value and the QP prediction value, and inverse quantize the current quantization block by using the determined QP value.

When the intra coding tool of the present disclosure is applied to the current block, the DQP may be determined with each subblock as a unit. In this case, the present disclosure may check a flag to determine whether to use DQP by subblock units or may check through high-level syntax whether to apply DQP.

In some examples, when the intra coding tool of the present disclosure is applied to the current block, the same QP may be used for all subblocks. Accordingly, the QP value of the current block may be determined by using the QPs of the (left and/or upper) CUs adjacent to the current block and the transmitted DQP value. Alternatively, the QP value of the current block may be inferred through the transmitted DQP value and high-level syntax.

In some other examples, a different DQP may be used for each subblock. In this case, the QP of each subblock may be determined by using the QP determined for the current block and the DQP value of each subblock. Alternatively, the QP of each subblock may be determined through DQP between the respective subblocks, or the QP of the current block may be determined by using the QP of a specific subblock.

In some other examples, the QP of the current block may be signaled or the value of the QP to be used may be inferred through a high-level syntax.

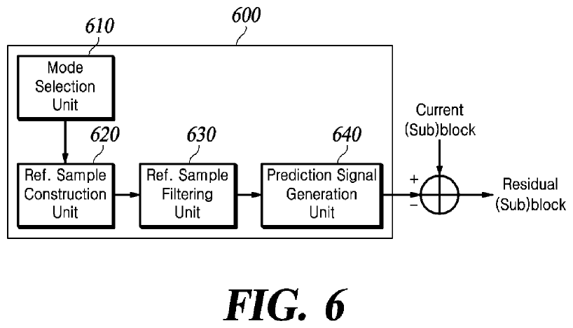

FIG. 6 is a functional block diagram illustrating an example configuration of an intra prediction unit in a video encoding apparatus according to at least one embodiment of the present disclosure, the intra prediction unit supporting the intra coding tool of the present disclosure. As shown in FIG. 6, an intra prediction unit 600 may include a mode selection unit 610, a reference sample construction unit 620, a reference sample filtering unit 630, and a prediction signal generation unit 640.

The mode selector 610 may determine an intra-prediction mode to be used for encoding the current block. For example, the mode selector 610 may encode the current block by using various intra-prediction modes and select an appropriate intra-prediction mode to be used from tested modes.

In some cases, the mode selector 610 may signal the intra-prediction mode for the current block by using a most probable mode (MPM) process. For example, the mode selector 610 may set intra-prediction modes of neighboring blocks adjacent to the current block, e.g., a block located at the top of the current block and a block located to the left of the current block, as MPM candidates. When no two MPM candidates can be found, e.g., when no neighboring block was intra-predicted or when the neighboring blocks have the same intra mode, the mode selector 610 may replace the intra-prediction mode of the neighboring block with a planar mode. When the number of MPM candidates included in the MPM candidate list is less than the maximum number (e.g., 6), the present disclosure may insert, in the MPM candidate list, default modes different from the previously inserted MPM candidates in the MPM candidate list and similar directional modes to the previously inserted MPM candidates.

Information, e.g., MPM flag, indicating whether the intra-prediction mode of the current block is the same as any one of the MPM candidates may be signaled through the bitstream. When the intra-prediction mode of the current block is the same as any one of the MPM candidates, the mode selector 610 may set the MPM flag to a first value and additionally signal MPM index information for identifying the coinciding MPM candidate. Alternatively, the mode selector 610 may first signal a flag indicating whether or not the intra-prediction mode of the current block is the planar mode, and if not, it may signal the MPM index information. When the intra-prediction mode of the current block matches none of the MPM candidates, the mode selector 610 may set the MPM flag to a second value and may signal residual mode information through the bitstream to indicate which of the remaining intra-prediction modes matches the intra-prediction mode of the current block.

The mode selector 610 may select the intra coding tool of the present disclosure that predicts the current block sequentially in units of subblocks. In this case, the mode selector 610 may perform rate-distortion analysis to determine the direction of splitting the current block into subblocks. In other words, the mode selector 610 may determine whether to divide the current block into multiple subblocks in the horizontal direction or into multiple subblocks in the vertical direction.

When the current block is predicted without being split into multiple subblocks, the mode selector 610 may set a split flag to a first value, e.g., ‘0’ indicating whether the current block is split or not. When the current block is predicted after being split into multiple subblocks, the mode selector 610 may set a split flag indicating whether the current block is split or not to a second value, e.g., ‘1’. The mode selector 610 may transmit the split flag to, for example, the entropy decoder 155 of FIG. 1 to signal the split flag.

In some cases, the mode selector 610 may be constrained from using the intra coding tool of the present disclosure described above unless predetermined criteria are met. For example, whether the intra coding tool of the present disclosure can be used may be determined depending on the position of the current block, the width and height of the current block, the area of the current block, the minimum transform size, the maximum transform size, and the like. In this case, the present disclosure may omit to signal the split flag indicating whether to use the intra coding tool thereof. This means that the split flag is not included in the bitstream.

For example, when the current block is smaller than a preset size (e.g., 4×8 or 8×4, etc.), the mode selector 610 may not use the intra coding tool of the present disclosure. As another example, the intra coding tool of the present disclosure is not applied and no split flag is signaled when the width and height of the current block are smaller than the minimum transform size, or when the current block's area (i.e., the number of pixels included in the current block) is smaller than the transform unit's area (i.e., the number of pixels included in the transform unit) defined by the minimum transform size. In this case, the video decoding apparatus infers the split flag as a value indicating that the current block is not split. As another example, signaling of the split flag may be omitted when the width and height of the current block are greater than the maximum transform size. In this case, the video decoding apparatus may be implemented to infer the split flag as a value indicating that the current block is split into multiple subblocks and intra-predicted by each subblock. Alternatively, the video decoding apparatus may infer that the split flag is a value indicating that the current block is not split into subblocks.

When the intra coding tool of the present disclosure is applied to the current block, the direction and number of subblock partitions may be determined based on the size of the current block, the position of the current block, the length of one side (i.e., width or height) of the current block, the number of pixels included in the current block, the intra-prediction mode of the current block, the size of the minimum or maximum transform block, and the like.

Information about the direction and number of subblock partitions may be provided in various ways. For example, the mode selector 610 may use one or more syntax elements such as a 1-bit flag to signal the direction and number of subblock partitions.

In some cases, the number of subblocks may be determined by the width and height of the current block. For example, when the width and height of the current block are 4×8 or 8×4, the number of subblocks may be determined to be 2, and when the width and height of the current block are greater than 4×4 and not equal to 4×8 and 8×4, the number of subblocks may be determined to be 4. As another example, when the width and height of the current block are 4×8 or 8×4, the number of subblocks may be determined to be 2, and when the width and height of the current block are 8×N to 32×N or N×8 to N×32 (here, N>4), the number of subblocks may be determined to be 4, and the number of subblocks may be determined to be 8 for current blocks larger than 32×N and N×32.

Whether the split direction is horizontal or vertical may be determined by split information. Alternatively or supplementally, the split direction may be determined (or inferred) based on the ratio of the width to height of the current block. For example, the split direction may be determined as horizontal split when the width of the current block is greater than the height thereof and may be determined as vertical split when the width of the current block is smaller than the height thereof. Alternatively or supplementally, when the current block exists at the boundary of a picture (or a tile, a group of tiles, etc.), the shape and number of subblock partitions may be inferred according to the position of the current block. Additionally, whether the split direction is horizontal or vertical may be determined based on the directionality of prediction modes included in intra-prediction mode candidates (i.e., MPM list) determined for the current block. This may exempt the bitstream from signaling one or more syntax elements indicating information on the shape and/or the number of subblock partitions.

The reference sample construction unit 620 may check for available neighboring samples and use the available samples for constructing reference samples to be used for prediction. When no available sample exists or when no intra prediction is performed using neighboring samples, the reference sample constructing unit 620 may arbitrarily construct a reference sample.

The reference sample filtering unit 630 may determine whether to perform filtering. Whether to perform filtering may be determined based on information on at least one of the size, depth, QP, and mode of the current block. When filtering needs to be performed, the reference sample filtering unit 630 may select a filter to perform filtering. In this case, information on which filtering to perform may be signaled in the bitstream.

The prediction signal generation unit 640 may generate a prediction subblock by predicting a subblock to be encoded among the multiple subblocks from previously reconstructed pixels around the subblock. The prediction signal generation unit 640 may use the intra-prediction mode determined for the current block in performing intra prediction of multiple subblocks. Then, the prediction subblock may be subtracted with respect to the corresponding subblock of the current block to generate a residual subblock. The residual subblock may be reconstructed through a transform/quantization process and an inverse quantization/inverse transform process. The reconstructed residual subblock is summed with the prediction subblock generated by the prediction signal generation unit 640 to generate a reconstructed subblock. In particular, when predicting the next subblock, the prediction signal generation unit 640 may use the reconstructed pixels of the previous subblock and the reconstructed pixels of the previously reconstructed CU.

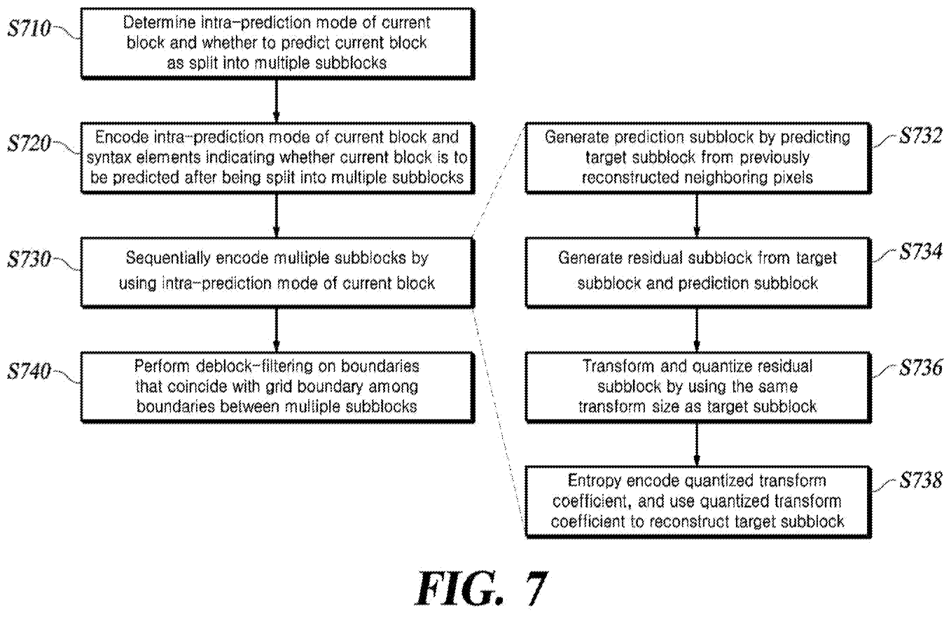

FIG. 7 is a flowchart of a method performed by a video encoding apparatus for intra-prediction encoding a current block of a video, according to at least one embodiment of the present disclosure.

In Step S710, the video encoding apparatus may determine an intra-prediction mode to be used for encoding the current block. Additionally, the video encoding apparatus may determine whether or not to apply the intra coding tool of the present disclosure and, if yes, determine the split direction of the current block between a horizontal direction and a vertical direction.

In Step S720, the video encoding apparatus may encode the intra-prediction mode of the current block and syntax elements indicating whether the current block is to be predicted after being split into multiple subblocks. The video encoding apparatus may use a most probable mode (MPM) process for signaling the intra-prediction mode for the current block. Further, the video encoding apparatus may signal a split flag indicating whether the current block is predicted after being split into multiple subblocks.

In some cases, the video encoding apparatus may be restricted from using the intra coding tool of the present disclosure unless predetermined criteria are met. For example, the intra coding tool of the present disclosure may be determined whether it can be used or not depending on the position of the current block, the width and height of the current block, the area of the current block, the minimum transform size, the maximum transform size, and the like. In this case, the present disclosure may omit signaling of a split flag indicating whether to use the intra coding tool of the present disclosure in the bitstream.

When the intra coding tool of the present disclosure is applied to the current block, the direction and number of subblock partitions may be determined based on the size of the current block, the position of the current block, and the length of one side (i.e., width or height) of the current block, the number of pixels included in the current block, the intra-prediction mode of the current block, the size of the minimum or maximum transform block, and the like.

Information about the direction and number of subblock partitions may be provided in various ways. For example, the video encoding apparatus may use one or more syntax elements such as a 1-bit flag to signal split information such as the direction and/or the number of subblock partitions.

In some cases, the number of subblocks may be determined by the width and height of the current block. For example, when the width and height of the current block are 4×8 or 8×4, the number of subblocks is determined to be 2, and when the width and height of the current block are greater than 4×4 and not equal to 4×8 and 8×4, the number of subblocks may be determined to be 4.

The video encoding apparatus may explicitly signal a flag indicating the direction of subblock partition, e.g., whether the direction is horizontal or vertical. Alternatively or supplementally, the split direction may be determined (or inferred) based on the ratio of the width to height of the current block. For example, the split direction may be determined as horizontal split when the width of the current block is greater than the height thereof and may be determined as vertical split when the width of the current block is smaller than the height thereof. In this case, the signaling of the flag indicating the split direction may be omitted.

In Step S730, when the intra coding tool of the present disclosure is applied to the current block, the video encoding apparatus may sequentially encode multiple subblocks by using the intra-prediction mode determined for the current block.

For example, the video encoding apparatus may generate a prediction subblock by predicting a target subblock to be encoded among multiple subblocks from previously reconstructed pixels around the target subblock (S732). The video encoding apparatus may generate a residual subblock from the target subblock and the prediction subblock (S734). The video encoding apparatus may transform and quantize the residual subblock by using the same transform size as the target subblock (S736). The video encoding apparatus may entropy-encode the quantized transform coefficient (S738). Further, the video encoding apparatus may reconstruct a residual subblock by applying an inverse quantization/inverse transform process to the quantized transform coefficient and may add the reconstructed residual subblock to the prediction subblock to generate a reconstructed subblock (S738). In particular, pixels in the reconstructed subblock may be used to intra-predict the next subblock in the current block. By this process, the current block is processed sequentially from the subblock including the top-left sample of the current block in the downward direction while in horizontal splitting and in the right direction while in vertical splitting.

In Step S740, the video encoding apparatus may perform deblock-filtering and other processes on the reconstructed current block, and may store the filtered current block in a buffer (e.g., memory 190 of FIG. 1) for use as a reference picture for inter prediction of the outstanding blocks to be encoded in the picture. The video encoding apparatus may set a grid of N samples at regular intervals in the horizontal and vertical directions, and perform deblock-filtering on boundaries that coincide with the grid boundary among boundaries between the multiple subblocks in the current block.

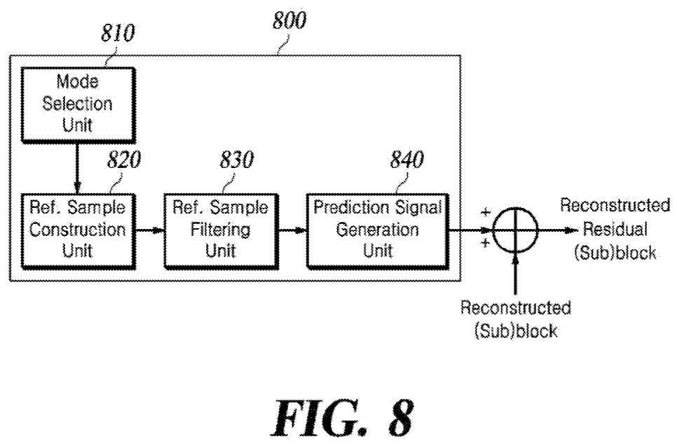

FIG. 8 is a functional block diagram illustrating an example configuration of an intra prediction unit in a video decoding apparatus according to at least one embodiment of the present disclosure, the intra prediction unit supporting the intra coding tool of the present disclosure. As shown in FIG. 8, an intra prediction unit 800 may include a mode determining unit 810, a reference sample construction unit 820, a reference sample filtering unit 830, and a prediction signal generation unit 840.

The mode determining unit 810 may determine an intra-prediction mode of the current block by decoding, from the bitstream, intra-prediction mode information of the current block. For example, the mode determining unit 810 may select a preset number of intra-prediction mode candidates from among a plurality of intra-prediction modes and uses the intra-prediction mode information of the current block to determine the intra-prediction mode of the current block from among the intra-prediction mode candidates.

The mode determining unit 810 may also determine whether to split the intra prediction coded current block into multiple subblocks. In particular, the mode determining unit 810 may split the current block into subblocks of the same size and determine whether to perform intra prediction for the respective subblocks by using the same intra-prediction mode as the intra-prediction mode of the current block.

For example, the mode determining unit 810 may decode, from the bitstream, a split flag indicating whether to split the current block and determine whether to split the current block into multiple subblocks based on the split flag. A first value, e.g., ‘0’ of the split flag indicates that the current block is not divided into subblocks, and a second value, e.g., ‘1’ of the split flag indicates that the current block was divided into subblocks and has been intra-predicted by each subblock.

The split flag may be inferred by the video decoding apparatus with no explicit signaling, i.e., with no decoding from the bitstream, but instead depending on the width and height of the current block, the area of the current block, the minimum transform size and/or the maximum transform size allowed for transforming transform coefficients. Accordingly, the mode determining unit 810 may infer the value of the split flag based on the width and height of the current block, the area of the current block, and the minimum and maximum transform sizes allowed for transforming transform coefficients.

In at least one embodiment, when the width and height of the current block are smaller than the minimum transform size, the split flag may need no decoding from the bitstream, but instead, be set to a value indicating that the current block is not split. In another embodiment, when the area of the current block (i.e., the number of pixels included in the current block) is smaller than the area of the transform unit (i.e., the number of pixels included in the transform unit) defined by the minimum transform size, the split flag may need no decoding from the bitstream, but instead, be set to a value indicating that the current block is not split. In yet another embodiment, when the width and height of the current block are greater than the maximum transform size, the split flag may need no decoding from the bitstream, but instead, it may be inferred that the split flag has a second value (e.g., ‘1’), i.e., that the current block has been split into multiple subblocks and intra-predicted by each subblock. Alternatively, on the contrary, it may be inferred that the split flag has a first value (e.g., ‘0’), i.e., that the coding tool of the present disclosure is not applicable, saving its process of splitting the current block into multiple subblocks and intra-predicting the respective subblocks.

When the coding tool of the present disclosure is applied to the current block, the mode determining unit 810 may determine the direction and number of subblock partitions. The mode determining unit 810 may extract one or more syntax elements from the bitstream to determine the direction and number of subblock partitions. For example, whether the split direction is horizontal or vertical may be explicitly signaled by using a syntax element such as a 1-bit flag. Accordingly, the mode determining unit 810 may extract, from the bitstream, the syntax element indicating the split direction of the current block.

Alternatively or supplementally, the direction and number of subblock partitions may be determined or inferred based on the size of the current block, the position of the current block, the length of one side (i.e., width or height) of the current block, the number of pixels included in the current block, the intra-prediction mode of the current block, the size of the minimum or maximum transform block, and the like.

For example, the split direction may be determined (or inferred) based on the ratio of the width to height of the current block. For example, the split direction may be determined as horizontal split when the width of the current block is greater than the height thereof, and may be determined as vertical split when the width of the current block is smaller than the height thereof. Alternatively or supplementally, when the current block exists at the boundary of a picture (or a tile, a group of tiles, etc.), the shape and number of subblock partitions may be inferred according to the position of the current block. Additionally, whether the split direction is horizontal or vertical may be determined based on the directionality of prediction modes included in intra-prediction mode candidates (i.e., MPM list) determined for the current block. This may exempt the bitstream from signaling one or more syntax elements indicating information on the shape and/or the number of subblock partitions.

The number of subblocks may be determined based on the size of the current block, the position of the current block, the length of one side (i.e., width or height) of the current block, the number of pixels included in the current block, the intra-prediction mode of the current block, the size of the minimum or maximum transform block, and the like.

In some cases, the number of subblocks may be determined by the width and height of the current block. For example, when the width and height of the current block are 4×8 or 8×4, the number of subblocks may be determined to be 2, and when the width and height of the current block are greater than 4×4 and not equal to 4×8 and 8×4, the number of subblocks may be determined to be 4. As another example, when the width and height of the current block are 4×8 or 8×4, the number of subblocks may be determined to be 2, and when the width and height of the current block are 8×N to 32×N or N×8 to N×32 (here, N>4), the number of subblocks may be determined to be 4, and the number of subblocks may be determined to be 8 for current blocks larger than 32×N and N×32.

The reference sample construction unit 820 may check for available neighboring samples and use the available samples for constructing reference samples to be used for prediction. When no available sample exists or when no intra prediction is performed using neighboring samples, the reference sample constructing unit 820 may arbitrarily construct a reference sample.

The reference sample filtering unit 830 determines whether to perform filtering. Whether to perform filtering may be determined based on information on at least one of the size, depth, QP, and mode of the current block. When filtering needs to be performed, the reference sample filtering unit 830 may select a filter to perform filtering. In this case, information on which filtering to perform may be extracted from the bitstream.

The prediction signal generation unit 840 may generate an intra-predicted subblock by predicting a subblock to be currently reconstructed among the multiple subblocks from previously reconstructed pixels around the subblock. In particular, when predicting the next subblock, the prediction signal generation unit 840 may use the reconstructed signal of the previous subblock and the reconstructed signal of the previously reconstructed CU. To generate a reconstructed subblock, the intra-predicted subblock may be summed with the reconstructed residual subblock from the bitstream.

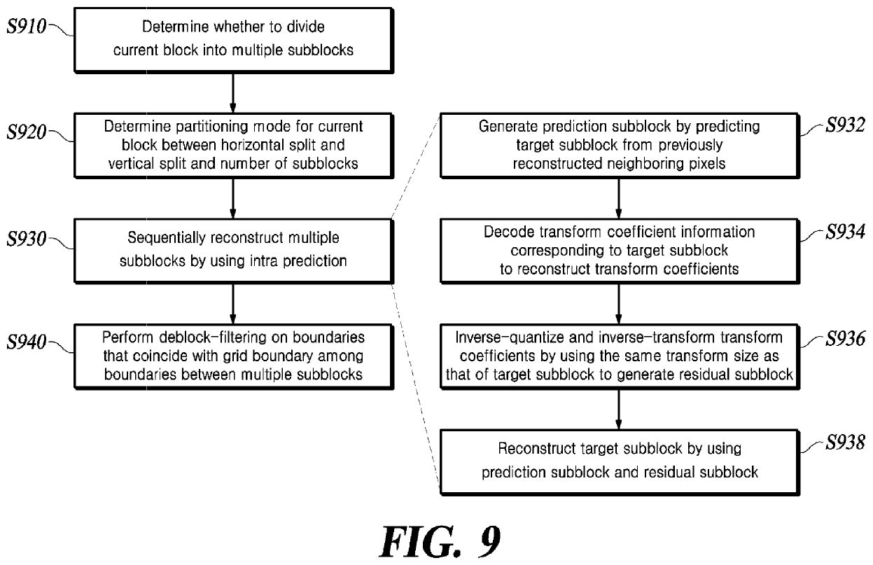

FIG. 9 is a flowchart of a method performed by a video decoding apparatus for decoding an intra-prediction encoded current block from a bitstream of an encoded video, according to at least one embodiment of the present disclosure.

In Step S910, the video decoding apparatus determines whether to divide the intra prediction-coded current block into multiple subblocks. In particular, the video decoding apparatus splits the current block into subblocks of the same size and determines whether to perform intra prediction on the respective subblocks by using the same intra-prediction mode as the intra-prediction mode of the current block.

For example, the video decoding apparatus may decode, from the bitstream, a split flag indicating whether to split the current block and determine whether to split the current block based on the split flag. A first value (e.g., “0”) of the split flag may indicate that the current block was not split into multiple subblocks, and a second value (e.g., “1”) of the split flag may indicate that the current block was split into multiple subblocks and has been intra predicted by each subblock.

The split flag may be inferred by the video decoding apparatus with no explicit signaling, i.e., with no decoding from the bitstream, but instead depending on the width and height of the current block, the area of the current block, the minimum transform size, and the maximum transform size allowed for transforming transform coefficients. Accordingly, the video decoding apparatus may infer the value of the split flag based on the width and height of the current block, the area of the current block, and the minimum and maximum transform sizes allowed for transforming transform coefficients.

In Step S920, the video decoding apparatus may be responsive to when the current block is split into multiple subblocks for determining a split direction for the current block between a horizontal split direction and a vertical split direction and the number of the subblocks based on split information decoded from the bitstream and a width and a height of the current block.

Whether the split direction is horizontal or vertical may be determined by the split information. Alternatively or supplementally, the split direction may be determined based on the ratio of the width to height of the current block. For example, the split direction may be determined as horizontal split when the width of the current block is greater than the height thereof and may be determined as vertical split when the width of the current block is smaller than the height thereof.

The number of subblocks may be determined by the width and height of the current block. For example, when the width and height of the current block are 4×8 or 8×4, the number of subblocks may be determined to be 2, and when the width and height of the current block are greater than 4×4 and not equal to 4×8 and 8×4, the number of subblocks may be determined to be 4.

In Step S930, the video decoding apparatus reconstructs the current block by sequentially reconstructing the multiple subblocks split according to the split direction and the number of subblocks, through intra prediction.

For example, the video decoding apparatus may generate an intra-predicted subblock by predicting a target subblock to be encoded among the multiple subblocks from previously reconstructed pixels around the target subblock (S932). The video decoding apparatus may decode, from the bitstream, transform coefficient information corresponding to the target subblock to reconstruct transform coefficients (S934), and inversely quantize and inversely transform the transform coefficients by using the same transform size as that of the target subblock to generate a residual subblock having residual signals (S939). The video decoding apparatus may reconstruct the target subblock by using the intra-predicted subblock and the residual subblock (S938). Pixels in the reconstructed subblock may be used for intra prediction of the next subblock in the current block.

Additionally, in or prior to Step S930, the video decoding apparatus may decode intra-prediction mode information of the current block from the bitstream to determine the intra-prediction mode of the current block. For example, the video decoding apparatus may select a preset number of intra-prediction mode candidates (i.e., MPM candidates) from among a plurality of intra-prediction modes, and use intra-prediction mode information of the current block to determine the intra-prediction mode of the current block from among the MPM candidates. The intra-prediction mode candidates may be selected in different ways according to whether the split direction is horizontal or vertical. For example, when the split direction is horizontal, vertical-oriented modes may be selected as the MPM candidates among the plurality of intra-prediction modes in preference to horizontal-oriented modes. Additionally, when the split direction is vertical, the horizontal-oriented modes may be selected as the MPM candidates among the plurality of intra-prediction modes in preference to the vertical-oriented modes.

Further, in or before Step S930, the video decoding apparatus may decode, from the bitstream, a subblock flag indicating whether a non-zero transform coefficient exists in the target subblock based on a position of the target subblock in the current block and the number of the subblocks. In this case, the video decoding apparatus may reconstruct transform coefficients corresponding to the target subblock from the bitstream when the subblock flag indicates that the non-zero transform coefficient exists in the target subblock. Unless the subblock flag is decoded from the bitstream, the video decoding apparatus may set the subblock flag to a value indicating that the non-zero transform coefficient exists in the subblock.

In Step S940, the video decoding apparatus may perform deblock-filtering on the reconstructed current block, and may store the filtered current block in a buffer (e.g., memory 470 of FIG. 4) for use as part of a reference picture for inter prediction of the outstanding blocks to be coded in the picture. The video decoding apparatus may set a grid of N samples at regular intervals in the horizontal and vertical directions, and perform deblock-filtering on boundaries that coincide with the grid boundary among boundaries between the multiple subblocks in the current block.

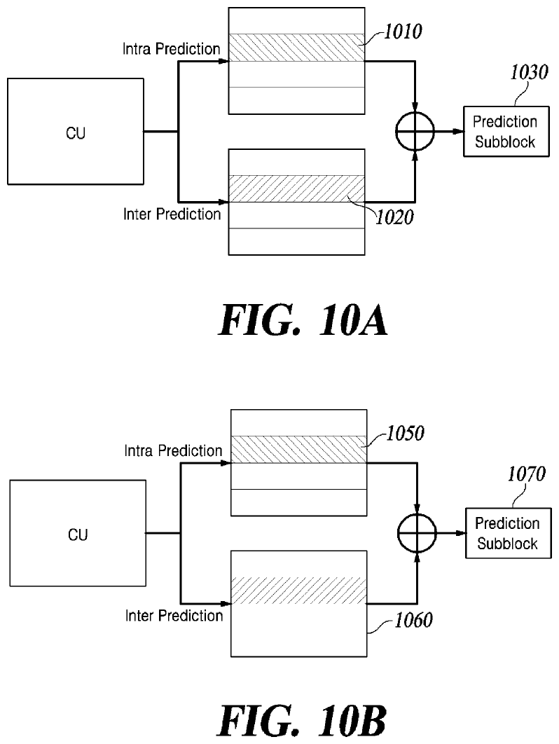

Meanwhile, when a block (CU) is coded sequentially in units of subblocks according to the above-described intra coding tool, both intra prediction and inter prediction may be performed in generating a prediction signal (to be added to a relevant residual signal) of a subblock. FIGS. 10A and 10B are diagrams illustrating a coding block having a first subblock reconstructed first and a second subblock that is in the reconstruction process while generating a prediction subblock of the second subblock.

As illustrated in FIG. 10A, where the first subblock has been reconstructed and the second subblock of the coding block (CU) is in the reconstruction process, a weighted sum (or weighted average) is performed on a prediction subblock 1010 from intra-predicting the second subblock in an intra-prediction mode and a prediction subblock 1020 from inter-predicting the second subblock, thereby generating a final prediction subblock 1030 (to be added to the relevant residual signal) of the second subblock. Here, for inter-prediction in units of subblocks, motion information may be signaled in units of subblocks individually or motion information signaled for the coding block (CU) may be commonly used for all subblocks of the CU.

When the CU is reconstructed sequentially in units of subblocks, a prediction block 1060 from inter-predicting the CU may be used in the reconstruction process of the respective subblocks. As illustrated in FIG. 10B, where the first subblock has been reconstructed and the second subblock of the coding block (CU) is in the reconstruction process, a weighted sum (or weighted average) is performed on (1) a prediction subblock which is corresponds to the second subblock and is extracted from a prediction block 1060, and (2) the prediction subblock 1010 which is generated from intra-predicting the second subblock, thereby generating the final prediction subblock 1030 of the second subblock. The prediction block 1060 of the CU may have to be generated before generating the final prediction subblock for the first subblock, and be stored in a buffer up to generating the final prediction subblock for the fourth subblock.

Accordingly, in some embodiments, when the above-described intra coding tool is applied to the current block, the video decoding apparatus may reconstruct the current block sequentially in units of subblocks, in a manner of processing the target subblock to be reconstructed by: generating its intra-predicted subblock and inter-predicted subblock; performing weighted averaging on the two prediction subblocks to generate a final prediction subblock for the target subblock; and adding the final prediction subblock to the residual subblock decoded from the bitstream. This can reconstruct the target subblock.

It should be understood that the above description presents the illustrative embodiments that may be implemented in various other manners. The functions described in some embodiments may be realized by hardware, software, firmware, and/or their combination. It should also be understood that the functional components described in this specification are labeled by “ . . . unit” to strongly emphasize their stand-alone implementability.

Meanwhile, various methods or functions described in the present disclosure may be implemented as instructions stored in a non-transitory recording medium that can be read and executed by one or more processors. The non-transitory recording medium includes, for example, all types of recording devices in which data is stored in a form readable by a computer system. For example, the non-transitory recording medium may include storage media such as erasable programmable read only memory (EPROM), flash drive, optical drive, magnetic hard drive, and solid state drive (SSD) among others.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

1. A video decoding method for reconstructing a current block using intra prediction, the method comprising:
determining whether to split a current block into a plurality of subblocks;
when the current block is split into the plurality of subblocks, determining a split direction for the current block between a horizontal split direction and a vertical split direction and determining the number of the subblocks, based on split information decoded from a bitstream and a width and a height of the current block;
reconstructing the current block by sequentially reconstructing the subblocks, specified according to the split direction and the number of the subblocks, using intra prediction; and
setting a grid of N samples at regular intervals in horizontal and vertical directions and performing deblock-filtering on, among boundaries between the subblocks in the current block, boundaries that coincide with a boundary of the grid.

2. The method of claim 1, wherein the reconstructing of the current block comprises:
predicting a target subblock to be currently reconstructed from among the subblocks from previously reconstructed pixels around the target subblock to generate an intra-predicted subblock;
generating a residual subblock having residual signals by:
decoding, from the bitstream, transform coefficient information corresponding to the target subblock to reconstruct transform coefficients, and
inverse quantizing and inverse transforming the transform coefficients by using a transform size that is equivalent to the target subblock; and
reconstructing the target subblock by using the intra-predicted subblock and the residual subblock,
wherein pixels in the reconstructed target subblock are used for intra prediction of a subsequent subblock in the current block.

3. The method of claim 1, wherein the determining of whether to split the current block comprises:
decoding, from the bitstream, a split flag indicating whether to split the current block based on the width and height of the current block, an area of the current block, and a minimum transform size and a maximum transform size that are allowable for transforming transform coefficients; and
determining whether to split the current block based on the split flag.

4. The method of claim 3, wherein, when the width and the height of the current block are smaller than the minimum transform size, the split flag is not decoded from the bitstream and is set to a value indicating that the current block is not to be split.

5. The method of claim 3, wherein, when the area of the current block is smaller than an area of a transform unit defined by the minimum transform size, the split flag is not decoded from the bitstream and is set to a value indicating that the current block is not to be split.

6. The method of claim 3, wherein, when the width and the height of the current block are greater than the maximum transform size, the split flag is not decoded from the bitstream.

7. The method of claim 1, wherein whether the split direction is horizontal split direction or the vertical split direction is determined based on the split information, and
wherein the number of the subblocks is determined based on the width and the height of the current block.

8. The method of claim 1, wherein the number of the subblocks is set to 2 when the width and the height of the current block are 4×8 or 8×4, and
wherein the number of the subblocks is set to 4 when the width and the height of the current block are greater than 4×4 and not equal to 4×8 and 8×4.

9. The method of claim 1, wherein the split direction is determined as the horizontal split direction when the width of the current block is greater than the height of the current block, and
wherein the split direction is determined as the vertical split direction when the width of the current block is smaller than the height of the current block.

10. The method of claim 2, wherein the decoding of the transform coefficient information corresponding to the target subblock comprises:
decoding, from the bitstream, a subblock flag indicating whether a non-zero transform coefficient exists in the target subblock, based on a position of the target subblock in the current block and the number of the subblocks; and
reconstructing transform coefficients corresponding to the target subblock from the bitstream when the subblock flag indicates that the non-zero transform coefficient exists in the target subblock.

11. The method of claim 10, wherein, unless the subblock flag is decoded from the bitstream, the subblock flag is set to a value indicating that the non-zero transform coefficient exists in the subblock.

12. The method of claim 1, further comprising:
determining the intra-prediction mode of the current block by decoding intra-prediction mode information of the current block from the bitstream, wherein
the subblocks are intra-predicted by using an intra-prediction mode that is equivalent to the intra-prediction mode information of the current block.

13. The method of claim 12, wherein the determining of the intra-prediction mode of the current block comprises:
selecting a preset number of intra-prediction mode candidates from among a plurality of available intra-prediction modes; and
determining an intra-prediction mode of the current block from among the intra-prediction mode candidates by using the intra-prediction mode information of the current block,
wherein the intra-prediction mode candidates are selected in different ways depending on whether the split direction is the horizontal split direction or the vertical split direction.

14. The method of claim 13, wherein:
when the split direction is horizontal, among the plurality of available intra-prediction modes, vertical-oriented modes are selected as the intra-prediction mode candidates in preference to horizontal-oriented modes; and
when the split direction is vertical, among the plurality of available intra-prediction modes, the horizontal-oriented modes are selected as the intra-prediction mode candidates in preference to the vertical-oriented modes.

15. The method of claim 2, wherein the reconstructing of the current block comprises:
determining a motion vector of the target subblock and generating an inter-predicted subblock for the target subblock by using the motion vector; and
generating a prediction subblock for the target subblock by calculating a weighted average of the intra-predicted subblock and the inter-predicted subblock,
wherein the target subblock is reconstructed by adding up the prediction subblock and the residual subblock.
